(19) United States
(12) Patent Application Publication
(10) Pub. No.: US 2019/0069661 A1
(43) Pub. Date: Mar. 7, 2019

(54) INTEGRATED MAKEUP ACCESSORY AND CASE FOR A MOBILE PHONE DEVICE

(71) Applicant: Tesia Worley, Waianae, HI (US)

(72) Inventor: Tesia Worley, Waianae, HI (US)

(21) Appl. No.: 15/695,024

(22) Filed: Sep. 5, 2017

(51) Int. Cl. A45D 33/26; H04B 1/3888

(52) U.S. Cl. CPC A45D 33/26; A45C 2011/002; H04B 1/3888

(57) ABSTRACT

This invention describes a protective mobile phone device case that provides a convenient makeup accessory integrated with the case. The customizable makeup palette solution can be utilized with the functions of the mobile phone device to provide additional convenience for one (1) to four (4) makeup applicators, one (1) to six (6) functional slots designed to hold makeup tins ranging from 4 mm-60 mm, and mirror purposes to provide ornamental or decorative enhancements to the device holding everything securely within. Apertures for access to functional controls and connection of the said electronic device included.

### STATEMENT REGARDING FEDERALLY SPONSORED RESEARCH OR DEVELOPMENT

Not Applicable.

### REFERENCE TO SEQUENCE LISTING

References Cited: U.S. Pat. No. 9,643,767 B2 05/2017 Ziemba

### BACKGROUND

### Field of the Invention

This present invention relates to a protective case designed to house a mobile phone device and personal care/cosmetic products.

### Description of the Related Art

The present invention's purposefulness is to house a mobile device safely and be an all-in-one makeup compact including double-ended applicators, a mirror and one (1) to six (6) empty functional slots/holes designed to hold 4 mm-60 mm pan size interchangeable modules.

In the view of the foregoing, the Integrated Makeup Accessory and Case for a Mobile Phone Device described in this application provides for a portable convenient makeup palette integrated with a protective phone case to provide for a variety of purposes as described below.
a. A case; current makeup palettes are becoming more customizable with the common use of interchangeable modules. However, none of the pro makeup palettes provide a protective case for a portable electronic device. This invention does.
b. A makeup accessory; conversely, other protective cases are designed to house personal electronic devices specifically cellular and smart phones only. These cases do not allow for personal care and cosmetic/makeup items to be held securely within case. This invention does.
c. Customizable; current combinations of cellular telephone and personal care product cases fail to meet the needs of the current targeted consumer, for example US Patent Number 20110089078, discloses a second cell compartment for health care products, cards or keys. Unlike this invention the first compartment is designed to receive a personal mobile electronic device such as a cellular or smart phone and the second compartment holding two pieces together by a hinge and clasp includes applicators, a mirror and the empty functional holes to hold interchangeable modules.
d. Convenience; instead of carrying around an additional bag of makeup for touchups, this invention provides the convenience of having your favorite makeup necessities attached to your phone which includes double-ended applicators, a mirror and 1-6 empty functional slots/holes designed to hold 4 mm-60 mm pan size interchangeable modules.
e. Functional applicators; clasps within the case hold makeup applicators in place so you may apply your makeup.
f. Magnification; the mirror is a useful tool for personal care including makeup application, tweezing or face checks
g. Ornamental or decorative purposes; interchangeable and customizable features allows the invention to showcase different looks.

### SUMMARY OF THE INVENTION:

The Integrated Makeup Accessory and Case for a Mobile Phone Device described in this application provides a protective case for a mobile phone device with a rear compartment that allows the user to store personal care and cosmetic items that are interchangeable therein in one compact handheld apparatus.

In one embodiment of the present invention, the integrated makeup accessory and case for a mobile phone device is sectioned three ways, 1. A major compartment houses a personal electronic portable device; and a rear compartment that opens up to two separate parts; 2. The first said part would be on the structural backing of the rear surface of the case housing the mirror and applicators; 3. The second said part would be a hinged compartment housing multiple customizable interchangeable modules for cosmetic items held securely within by readily made slots. Both said parts connect with a hinge and securely close with a clasp. The hinge allows this said part to be removable so it is customizable and interchangeable as a whole to the user.

Preferably, the rear compartment part A would be on the structural backing of the rear surface of the case housing a mirror and one (1) to four (4) applicators integrated within. These included applicators are single or double-sided brushes interchangeable by a connector in the middle. Leading brushes available would be lip brush, eye shadow brush, blush/highlight brush, foundation brush, eyebrow brush and concealer brush.

Also preferred, the rear compartment part B would house multiple customizable interchangeable cells ideal to encompass (fit) one (1) to six (6) makeup pans ranging from 4 mm-60 mm and are customizable by the user. Rear compartment part B is a detachable compact makeup palette held to the rear compartment part A by hinge. The hinge allows this said part to be removable so it is customizable and interchangeable as a whole to the user. The hinge allows part B to open up to an angle i.e. a. 130 degree; b. 180 degree angle; both said parts are connected with the hinge and securely close with a clasp. Apertures for access to functional controls and connection of the said electronic device included.

### BRIEF DESCRIPTION OF THE DRAWINGS

For a more comprehensive understanding of the features, objects and advantages of the present invention, references should be had to the detailed descriptions below along with the accompanied drawings in which:

FIG. 1 A diagram that illustrates all internal components of case assembled; with a closeup of hinge “Detail 30”

FIG. 2 A detailed illustration of Part A with an included isometric cutaway view

FIG. 3 A detailed illustration of Part B with an included isometric cutaway view

### DETAILED DESCRIPTION

The Integrated Makeup Accessory and Case for a Mobile Phone Device described in this application provides a protective case for a mobile phone device with a rear compartment that allows the user to store personal care and cosmetic items that are interchangeable therein in one compact handheld apparatus.

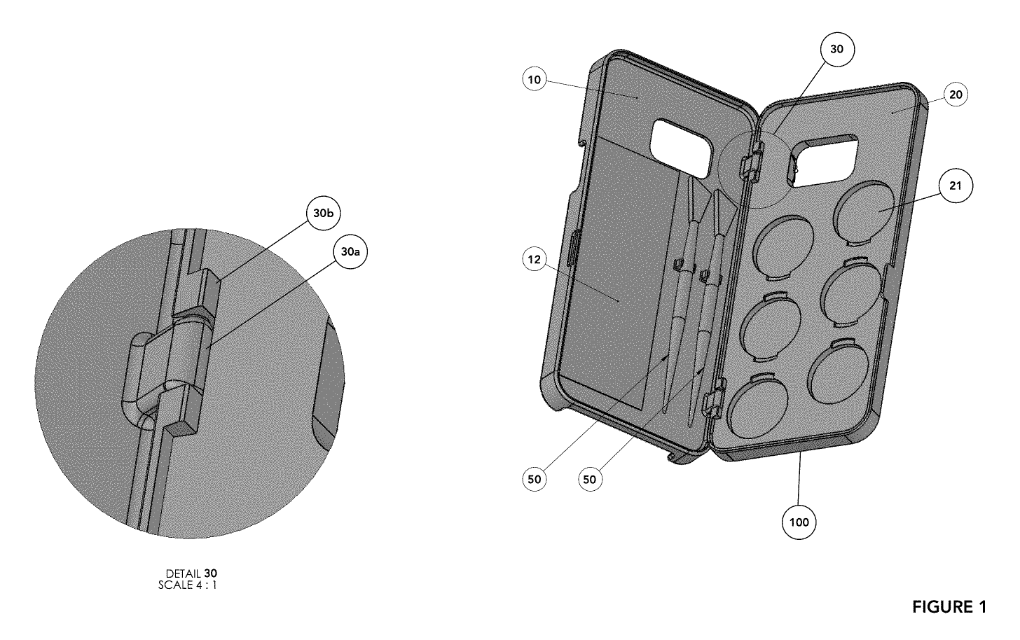

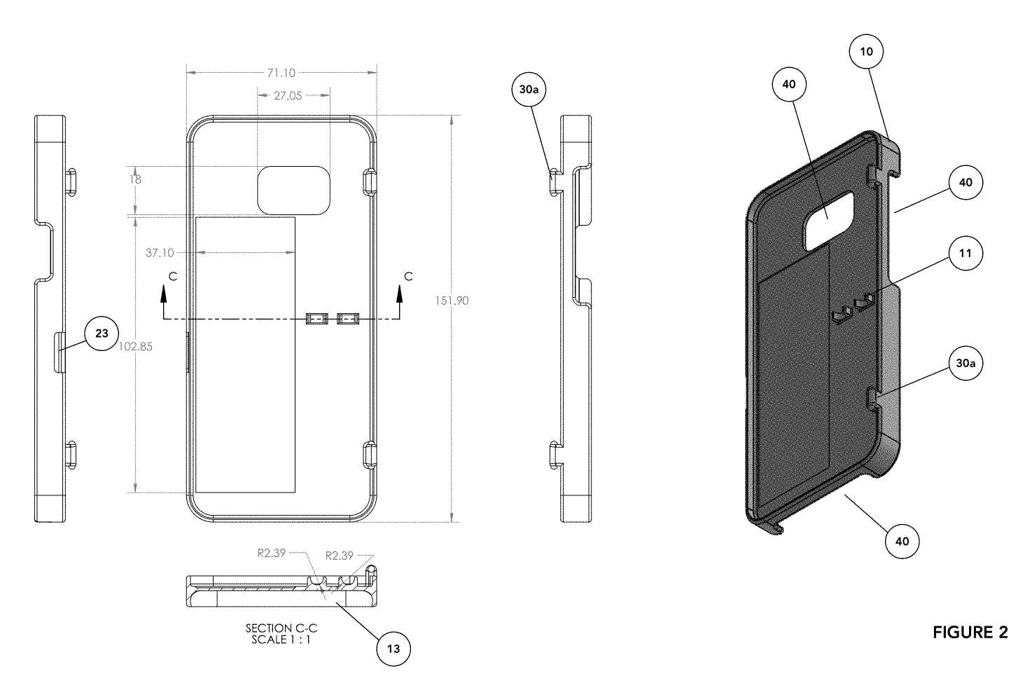

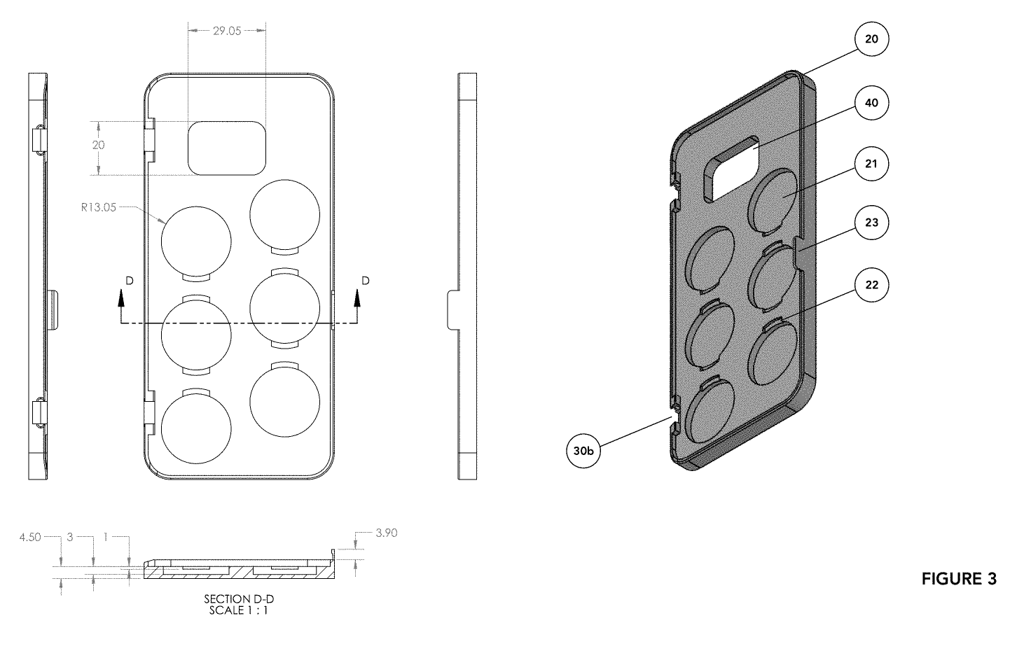

In one embodiment of the present invention, the integrated makeup accessory and case for a mobile phone device (FIG. 1) is sectioned three ways, 1. A major compartment houses a personal electronic portable device; and a rear compartment that opens up to two separate parts (FIGS. 2 and 3); 2. The first said part would be on the structural backing of the rear surface (10) of the case housing the mirror (12) and applicators (50); 3. The second said part (20) would be a hinged compartment housing multiple customizable interchangeable modules for cosmetic items held securely within by readily made slots (21). Both said parts connect with a hinge (30) and securely close with a clasp (23). The hinge allows this said part to be removable so it is customizable and interchangeable as a whole to the user.

(FIG. 2) The rear compartment Part A would be on the structural backing of the rear surface (10) of the case housing a mirror (12) and one to four applicators (50) integrated within. The included applicators are single or double-sided brushes (50) and each will be held in place by a snap clasp (11) next to the mirror (12) of the said Part A (10).

(FIG. 3) The rear compartment Part B (20) would house multiple customizable interchangeable cells (21) ideal to encompass (fit) one to six makeup pans ranging from 4 mm-60 mm. A pre-fashioned groove (22) allows access to remove and replace interchangeable makeup pans. Rear compartment Part B is a detachable compact makeup palette held to the rear compartment part A by hinge (30). The said hinge would be preferably ball-in-socket in nature (30a and 30b) to allow this said part to be removable so it is customizable and interchangeable as a whole to the user. FIG. 1 Illustrates the hinges capacity of opening to a preferred angle of 130 degrees and max angle of 180 degrees; both said parts securely close with a clasp (23). Apertures (40) for access to functional controls and connection of the said electronic device included.

What is claimed is:

1. An apparatus comprising:
An Integrated Makeup Accessory and Case for a Mobile Phone Device; provide the protecting of a mobile phone device and the convenient use of a makeup palette, applicators and mirror in conjunction with functionality native to the phone device;
a) An Integrated Makeup Accessory and Case for a Mobile Phone Device; comprised of: 1. A major compartment housing a personal electronic portable device; and a rear compartment split into two parts connected by a hinge and clasp. 2. Part A houses a mirror and applicators. 3. Part B houses slots with interchangeable modules;
b) The said protective cellular phone case will also have multiple opening accesses to camera and buttons. Apertures for access to functional controls and connections of the said electronic device included.

2. An Integrated Makeup Accessory and Case for a Mobile Phone Device of claim 1, the rear compartment made up of Part A and Part B will be hinged together
a) The hinge allows Part B to be removable so it is customizable and interchangeable as a whole to the user.

3. An Integrated Makeup Accessory and Case for a Mobile Phone Device of claim 2, wherein said rear compartment Part B houses slots with interchangeable modules. A module is defined as a small metal tin pan ranging from 4 mm-60 mm.
a) The rear compartment part B houses multiple customizable interchangeable cells ideal to encompass (fit) one (1) to six (6) makeup pans

4. An Integrated Makeup Accessory and Case for a Mobile Phone Device of claim 3, slots with interchangeable modules customizable by user can consist of foundation, lip color, concealer, blush, highlight powder, setting powder, eye shadow, eyebrow powder/gel

5. An Integrated Makeup Accessory and Case for a Mobile Phone Device of claim 2, rear compartment Part A attached to the rear surface of the personal electronic portable device houses a mirror and one (1) to four (4) applicators.
a) The mirror would be fastened to one side of the said Part A
b) The included applicators are single or double-sided brushes and will be held in place by a snap clasp each or something similar next to the mirror of the said Part A
c) Double-sided brushes with the option, can be interchangeable by a connector in the middle
d) Makeup applicators available are six (6) long-lasting brushes for lips, shadow, blush/highlight, foundation, brow and concealer
